(19) United States
(12) Patent Application Publication
(10) Pub. No.: US 2020/0234218 A1
(43) Pub. Date: Jul. 23, 2020

(54) SYSTEMS AND METHODS FOR ENTITY PERFORMANCE AND RISK SCORING

(71) Applicant: Samuel Salloum, Dearborn, MI (US)

(72) Inventor: Samuel Salloum, Dearborn, MI (US)

(21) Appl. No.: 16/746,357

(22) Filed: Jan. 17, 2020

Related U.S. Application Data
(60) Provisional application No. 62/794,024, filed on Jan. 18, 2019.

(51) Int. Cl. G06Q 10/06; G06N 20/00; H04L 29/08

(52) U.S. Cl. CPC G06Q 10/06393; H04L 67/20; G06N 20/00

(57) ABSTRACT

A method for data aggregation includes identifying one or more universal data elements. The method further includes receiving profile information for an entity, the entity being associated with the one or more universal data elements. The method further includes receiving commercial activity information and documentation information associated with the entity. The method further includes identifying, validating and generating an Ultimate Data Quality (UDQ) using the one or more universal data elements, the profile information, the commercial activity information, and the documentation information. The method further includes generating performance attribute metrics associated with the entity based on the UDQ and one or more performance factors associated with the entity. The method further includes generating an overall performance score for the entity using the performance attribute metrics.

### CROSS-REFERENCE TO RELATED APPLICATIONS

This application claims the benefit of U.S. Provisional Application No. 62/794,024 filed on Jan. 18, 2019 and which is hereby incorporated by reference.

### TECHNICAL FIELD

This disclosure relates to big data analytics (e.g., Business Intelligence and Big Data Analytics, Big Data Weighting and Aggregation), Predictive Analytics, Artificial Intelligence and Machine Learning, Sentiment Analysis, and Dynamic Score Generation.

### BACKGROUND

The world of digital information is growing at an exponential rate. However, current systems and methods at hand, in online commerce, are not sufficient to keep pace with such growth in order to properly and efficiently evaluate such information for appropriate entity performance and risk scoring of participants towards increasing the conversion ratios from seeing a product or service to its acquisition. Typically, current systems and methods that evaluate and process digital information pertaining to the participants are primarily based on Non-Validated Data (NVD), which is provided by a single source without validation and has a high degree of dependency on unsubstantiated customer behavior such as reviews, likes, and dislikes. More than 90% of data in use today is based on NVD. Consequently, entities may be unable to make appropriate decisions when engaging in transactions for products and/or services.

### SUMMARY

This disclosure relates generally to memory management systems and methods.

An aspect of the disclosed embodiments is a method for data aggregation. The method includes identifying one or more universal data elements. The method further includes receiving profile information for an entity, the entity being associated with one or more universal data elements. The method further includes receiving commercial activity information and documentation information associated with the entity. The method further includes identifying and generating Ultimate Data Quality (UDQ) using one or more universal data elements, the profile information, the commercial activity, and the documentation information. The method further includes automatically generating performance attribute metrics associated with the entity based on the UDQ and each performance attribute metric computed from one or more performance factors associated with the entity and relevant to a performance attribute area. The method further includes automatically generating an overall performance score for the entity using the performance attribute metrics.

As aspect of the disclosed embodiments include a system that includes a set of cloud platforms and an analytics platform. The set of cloud platforms may include at least one of: an e-commerce platform, an e-logistics platform, an e-finance platform, or an e-insurance platform. The analytics platform may include one or more communication interfaces for interacting with the set of cloud platforms, one or more memories, and one or more processors that are communicatively coupled to the one or more memories. The one or more processors may be configured to identify, using a data intake module, one or more universal data elements. The one or more processors may be configured to receive, using the data intake module and via at least one of the one or more communication interfaces, profile information for an entity, the entity being associated with the one or more universal data elements. The one or more processors may be configured to receive, using the data intake module and via at least one of the one or more communication interfaces, commercial activity information and documentation information associated with the entity. The one or more processors may be configured to identify Ultimate Data Quality (UDQ) using the one or more universal data elements, the profile information, the commercial activity information, and the documentation information. The one or more processors may be configured to generate performance attribute metrics associated with the entity based on the UDQ and one or more performance factors associated with the entity. The one or more processors may be configured to generate an overall performance score for the entity using the performance attribute metrics.

An aspect of the disclosed embodiments includes systems and methods for an entity performance and risk scoring mechanism through data aggregation and analysis for computing the entity performance and risk measures known as AxioScore™. The systems and methods include identifying at least one universal data element pertaining to online commercial marketplace transactions and other relevant information. The systems and methods further include receiving profile information for an entity associated with one or more universal data elements. The systems and method further include receiving commercial activity information and documentation information associated with the entity. In some embodiments, the systems and methods further include identification and creation of contextualized entity information from real-life transactional activities of participants, thereby allowing generation of dynamically validated transactional information that results in Ultimate Data Quality (UDQ). In some embodiments, the systems and methods further include analysis and identification of the one or more universal data elements from the profile information, the commercial activities, and the associated documentation information, thereby allowing generation of validated information with the UDQ. The system and methods further include generating performance attribute metrics (e.g., AxioScore™ Attributes) associated with the entity, wherein each performance attribute metric represents an entity performance measure in a critical functional area. The systems and methods further include computation of each performance attribute metric (e.g., an AxioScore™ Attribute) using one or more underlying performance factors within the relevant functional area of the associated entity. The systems and methods further include generating an overall performance score (e.g., an AxioScore™) representing overall performance and risk measure of the entity using the relevant performance attribute metrics (e.g., AxioScore™ Attributes), where each one of which is aggregated further from the underlying performance factors.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is flowchart of an example process described herein.

FIG. 2 is a flow diagram illustrating example data types used to generate an AxioScore™

FIG. 3A illustrates an example of an interface for a system using the performance and risk scores according to the principles of the present disclosure.

FIG. 3B illustrates an example of a risk attribute scores chart according to the principles of the present disclosure.

FIG. 4 illustrates an example interface for a system depicting an example use of aggregated performance and risk scores and underlying performance attribute scores according to the principles of the present disclosure.

FIG. 5 illustrates an example interface for a system depicting an example of the Quality Performance Attribute and determination of an underlying performance factor using scored data according to the principles of the present disclosure.

FIG. 6 illustrates a flowchart of one or more example user-system interactions that utilize performance and risk scores and relevant attribute scores.

FIG. 7 illustrates an example of an e-commerce platform that supports multiple channel partners.

FIG. 8 illustrates an example of a multi-factor authentication screen for a user that is accessing an account associated with a digital economy platform.

FIG. 9 illustrates an example representation of the performance and risk score and its underlying attributes and relevant factors.

FIG. 10 illustrates an example interface of a profile of an entity.

FIG. 11 illustrates an example interface of a U-grid, a marketplace for logistics applications.

FIG. 12 illustrates an example of an e-logistics Value Stream (VVS) application.

FIG. 13 illustrates an example of an e-logistics CarriersNet application.

FIGS. 14A-D illustrate popup windows for different attributes and underlying factors of scored data.

FIGS. 15A-B illustrate an example of a computational model for the performance and risk scoring and priority sorting of the scored data.

FIG. 16 is a diagram of an example environment in which systems and/or methods, described herein, may be implemented.

FIG. 17 is a diagram of example components of one or more devices of FIG. 16.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

An entity, as used herein, may refer to an organization, a group of individuals, an individual, and/or the like. A participant, as used herein, may refer to an entity that engages in a transaction with one or more other entities. A transaction, as used herein, may refer to any exchange between two or more entities involving a product, a service, an intangible commodity, and/or the like. In some implementations, the transaction may be a commercial transaction (e.g., an e-commerce transaction and/or any other type of commercial transaction). Additionally, or alternatively, the transaction may be a B2B transaction, a B2C transaction, a B2G transaction, a C2C transaction, a C2G transaction, a G2G transaction, and/or the like.

AxioScore™ is a multi-dimensional objective measure of performance and risk that utilizes Artificial Intelligence and Big Data Analytics to process the minimum amount of Universal Data Elements (UDEs) required to efficiently process all transactional activities that have been dynamically validated by multiple parties creating an Ultimate Data Quality (UDQ).

AxioScore™ utilizes Artificial Intelligence and Big Data Analytics to filter the UDQ into specific performance and risk related attributes and factors to dynamically facilitate decision making, triggering actions with confidence for optimizing conversion ratios from seeing a product or service online to its acquisition, among others, thereby delivering enhanced efficiencies for transactions.

Universal Data Elements (UDE)

During commercial transactions, as many as 19 industry clusters exchange information. Nearly 80% of this data exchange is redundant. Accordingly, a digital economy platform minimizes the standardization requirements among industry clusters by capturing the minimum amount of data necessary, known as Universal Data Elements (UDE), to efficiently process all transactions. Hence the UDE represents the common denominator of information available in all the documents and forms shared by commercial participants.

### Ultimate Data Quality (UDQ)

A Digital Economy Platform exchanges the UDE through thousands of Applications to be used by the participants, either free of cost or at a charge via fees based on transaction, subscription or user seats. These Applications will generate high volumes of real-time transactional data (e.g., millions of records, billions of records, or more) to perform real-life actions that are continuously validated by multiple parties in the same pipeline. The dynamically validated Big Data may be referred to as UDQ, which will have a high degree of veracity and will power the proprietary AxioScore™. UDQ, as used herein, may refer to data that has been given a designation that is synonymous with high quality data (e.g., data may satisfy one or more quality thresholds), data has been validated by multiple sources, data satisfies a threshold level of accuracy and/or authenticity, and/or the like.

In some embodiments, universal data elements (e.g., which may include millions of fields, billions of elements, or more) may overlap between documents. For example, some universal data elements that are found in an insurance document may also be found in a logistics document. In some embodiments, the digital economy platform (or an external service) may identify and/or generate contextualized information based on real-life activities completed by participants and/or associated devices. In some embodiments, the digital economy platform may analyze and/or identify the universal data elements found in the profile information, the commercial activity information, the documentation information, and/or the like. For example, the digital economy platform (or an external service) may analyze the universal data elements to determine that particular universal data elements are found in multiple different types of documents, to identify relationships between universal data elements and/or documents, and/or the like.

### AxioScore™

AxioScore™ is based on a treasure of mined transactional data measured on a scale from 1 to 5, with 5 being the most attractive score, signaling the overall commercial viability of a prospective product and/or service, viability of a service provider and/or purchaser, and/or the like. In some implementations, AxioScore™ may represent an aggregation of performance attribute metrics, such as the 5-key “QFILI” attributes (Quality, Finance-ability, Insurability, Logistics Reliability and Dependability, and Integration). Additionally, or alternatively, AxioScore™ may represent an aggregation of one or more other performance attribute metrics, such as a performance attribute metric relating to security, a performance attribute metric relating to user satisfaction, and/or the like. In this way, AxioScore™ may be based on as many attributes as may be needed to satisfy quality standards, entity preferences, and/or the like.

Each of the attributes is comprised of numerous factors measuring the performance and risk profile of the user (e.g., the source entity) and its partner entities. The QFILI attributes of desired product/service can be ordered in a “priority display” to filter selections in accordance with commercial performance/risk preferences.

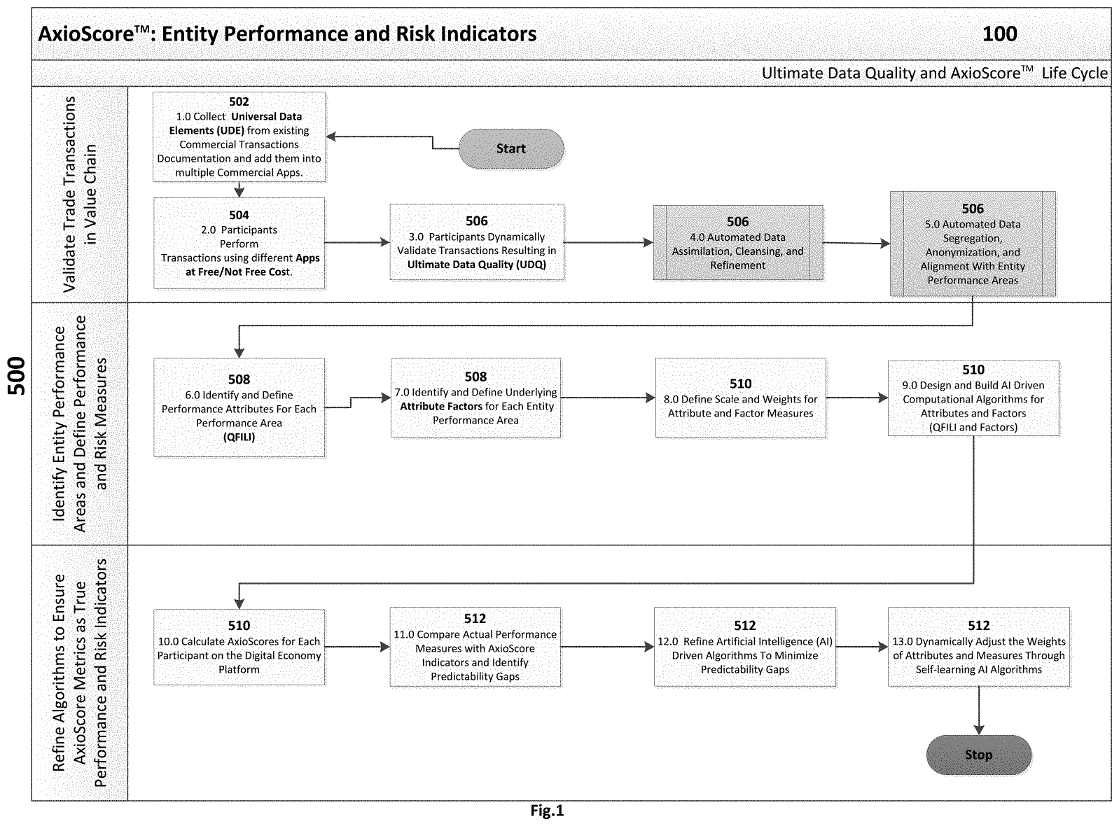

FIG. 1 is flowchart of a system 100 and illustrates a method 500 according to the principles of the present disclosure. In some implementations, method 500 may include a digital economy platform to validate transactions between a source entity and one or more other entities, to identify performance areas and risk measures associated with the source entity and/or the one or more entities, and to use machine learning to generate an overall performance score. The overall performance score may represent an overall level of commercial viability of an entity, of a product offering associated with the entity, of a service offering associated with the entity, and/or the like. In some implementations, the overall performance score may be an AxioScore™.

In a first step 502 (Step 1, Point 1), the digital economy platform may collect a set of Universal Data Elements (UDEs). For example, the digital economy platform may collect a set of UDEs from one or more data storage devices that are used to store documentation associated with transactions between entities.

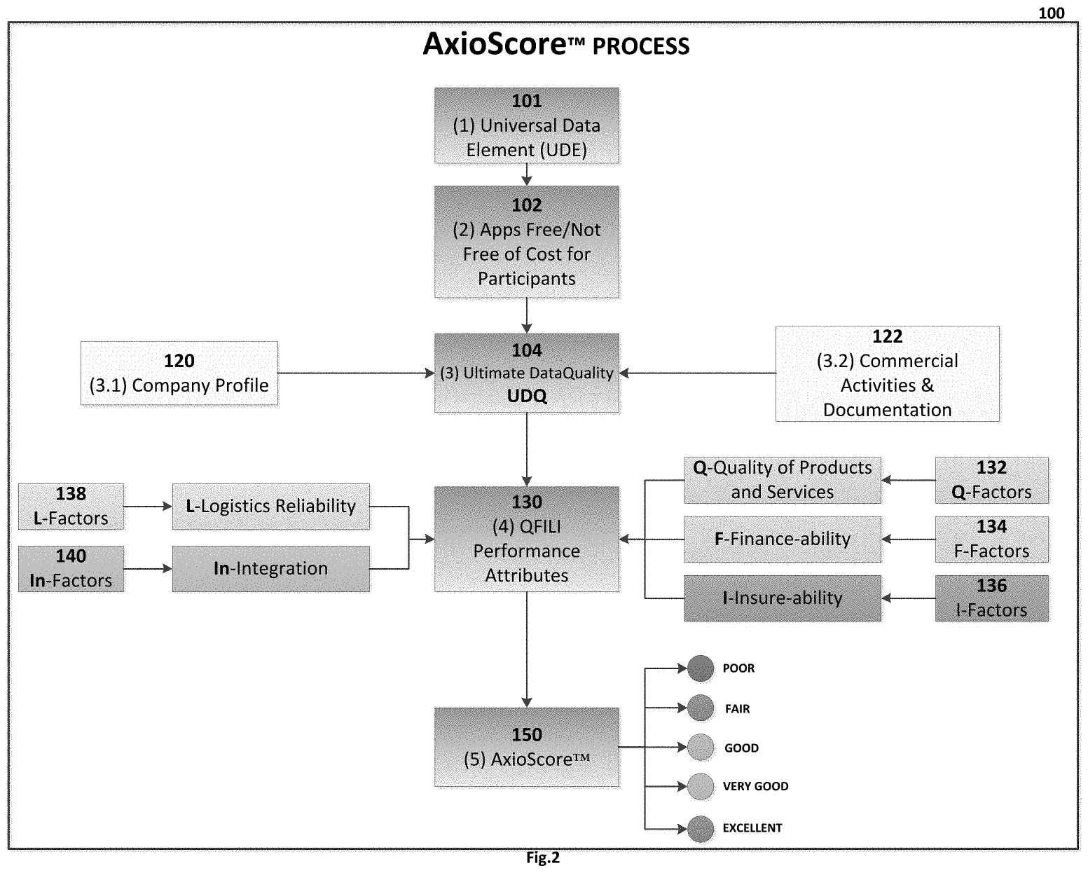

In a second step 504 (Step 2, Point 2), participants (e.g., entities, individuals, and/or the like) may engage in transactions using applications 102 (Free of cost or For Cost, as shown in FIG. 2). In some implementations, information associated with the transactions may be stored in a manner that is accessible to the digital economy platform (e.g., via one or more communication interfaces, such as an application programming interface (API)). The information associated with the transactions may include profile information of one or more entities, commercial activity information, documentation information, and/or the like.

In a third step 506 (Step 3, Points 3, 4, 5), the digital economy platform may identify an Ultimate Data Quality (UDQ), such as the UDQ 104 shown in FIG. 2. For example, and as shown by point 3, user devices operated by participants may be used to validate transactions and to generate UDQ 104. As shown by point 4, the digital economy platform may standardize, refine, and/or tag the information associated with the transactions.

As shown by point 5, the digital economy platform may filter the information associated with the transactions, such as by anonymizing the information associated with the transactions, by segmenting the information associated with the transactions, and/or the like. Data segmentation may be based on one or more entity performance areas, customized user-generated rules, and/or the like. In this way, the digital economy platform is able to identify the UDQ 104 based on information that is standardized, filtered, that aligns with entity performance areas, and/or the like.

In some implementations, the information processed by the digital economy platform may include millions of data points, billions of data points, or more. In this way, the quantity of data processed by the digital economy platform cannot be processed objectively by a human actor.

In a fourth step 508 (Step 4, Points 6, 7), the digital economy platform may identify a set of performance attribute metrics and/or a set of performance factors. In some implementations, the set of performance attribute metrics may include QFILI attributes and corresponding QFILI attribute factors. For example, the set of performance attributes may include AxioScore™ Performance Attributes and corresponding factors. Additionally, or alternatively, AxioScore™ may represent an aggregation of one or more other performance attribute metrics, such as a performance attribute metric relating to security, a performance attribute metric relating to user satisfaction, and/or the like.

In a fifth step 510 (Step 5, Points 8, 9, 10), the digital economy platform may generate an overall performance score (e.g., an AxioScore™, an aggregate performance and risk score, and/or the like) by using machine learning to weight the set of performance attribute metrics and/or the corresponding factors. In some implementations, the digital economy platform may generate an overall performance score for each entity and/or participant using applications 102.

In a sixth step 512 (Step 6, Points 12 and 13), the digital economy platform may dynamically adjust weights using machine learning. For example, and as shown by point 12, the digital economy platform may update a data model in a manner that minimizes predictability gaps. Additionally, and as shown by point 13, the digital economy platform may dynamically adjust weights of the data model that correspond to performance attribute metrics and/or performance factors. For example, the digital economy platform may compare performance data associated with actual performance with the generated overall performance score. This may allow the digital economy platform to determine gaps between the actual performance and predicted performance and to automatically adjust weights (e.g., weighted attributes) using machine learning. This allows the overall performance score to be continuously refined and recalibrated in real-time, thereby making the overall performance score a true indicator of future entity performance for participants that are utilizing applications 102.

In some implementations, the digital economy platform may cause the overall performance score and/or related information to be provided for display. For example, the overall performance score and/or related information may be displayed in a manner that is accessible to the source entity and/or other participants. Additional examples of interface displays are provided further herein.

Additionally, or alternatively, the digital economy platform may generate a recommendation based on the overall performance score. For example, if the overall performance score for a product or service provider corresponds to a low level of commercial viability, the digital economy platform may be configured to provide users with recommendations that assist in brainstorming ways to improve commercial viability (e.g., a recommendation to the supply chain process might improve logistic reliability of a product), recommendations that assist in brainstorming new product ideas, and/or the like.

Additionally, or alternatively, the digital economy platform may cause a user device to be provided with one or more documents that assist in launching a product or service. For example, if the overall performance score for a product satisfies a threshold level of commercial viability, the digital economy platform may be configured to provide users with access to documentation that describes the audience of the product or service (e.g., to further assist the user in the product release), documentation detailing any necessary security and/or privacy concerns relating to the release of the product or service, documentation detailing recommended actions that are to be performed prior to launching the product or service, and/or the like.

Additionally, or alternatively, the digital economy platform may recommend an entity and/or a product or service of the entity to one or more other entities. The recommendation may, for example, be based on the overall performance score satisfying a performance threshold. In this case, the digital economy platform may notify the entity and/or the one or more other entities of the recommendation (e.g., via an interface of applications 102, via e-mail, via text message, and/or via another type of communication interface).

Additionally, or alternatively, the digital economy platform may identify and recommend discounts, sales, and/or the like, that the source entity is eligible to receive based on the overall performance score. In this case, the digital economy platform may notify the entity and/or the one or more other entities of the recommendation.

By automatically generating scores using big data and analytics driven by machine learning, the digital economy platform reduces or eliminates human subjectivity by providing participants with an objective value to consider when determining whether to engage in particular transactions. Additionally, the digital economy platform conserves resources (e.g., computing resources, network resources, memory resources, and/or the like) that would otherwise be wasted by user devices to display subjective scores provided by an inferior scoring system.

Furthermore, by dynamically adjusting attribute weights of a data model trained using machine learning, the digital economy platform is able to efficiently and effectively generate accurate scores (e.g., relative to an inferior platform, relative to a platform that is unable to dynamically adjust attribute weights, and/or the like). Moreover, by generating scores in real-time, the scores represent an accurate and current snapshot of the commercial viability of an entity and/or product or service of the entity. This allows participants to make accurate assessments regarding which other participants to transact with and/or which transactions to engage in (e.g., assessments are accurate relative to an inferior platform that is unable to make real-time scoring decisions).

FIG. 2 is a diagram illustrating example data types used to generate an overall performance score, such as an AxioScore™ 150. For example, a digital economy platform may generate an AxioScore™ 150 based on QFILI performance attributes 130, whereby the QFILI performance attributes 130 are based on performance factors 132, 134, 136, 138, and 140, respectively, and a UDQ 104.

Universal Data Elements (UDEs) 101 are the common denominator fields within different transactions as well as forms, documents used by the participants. For example, UDEs 101 may include a Point of Loading (POL), Point of Discharge (POD), Status of Shipment, Procurement Order Status, or a name field, a date of birth field, a race field, an ethnicity field, a gender field, and/or the like.

Multiple applications 102 (provided free or at cost) will automatically populate the UDE into the forms and documents used in the Supply Chain or commercial transactions. The UDQ 104 is automatically generated from the validated commercial transactions and other data sets generated from applications 102. Each commercial transaction provides dynamically validated high quality data that is incorporated into the UDQ 104. For example, company profile data 120 and commercial activity and documentation 122 may be used as inputs, along with the UDE 101, to define the UDQ 104.

The digital economy platform aggregates the real-time data from UDQ 104 into a single performance and risk metric (e.g., the overall performance score) that is aggregated from performance attribute metrics of critical business functions for example a set of performance attribute metrics, such as the five “QFILI” attributes 130 shown in FIG. 2. The QFILI attributes 130 can be summarized as follows:

(Q) stands for Quality of Product/Service. The attribute Q assesses the user's quality based on various factors such as product, product components, and company quality. The quality attribute Q is computed from many relevant Q-factors 132 which may include certifications, awards, longevity of the parties, repeat sales to long-term customers, frequency of sales, product returns, defective goods, and/or the like. Each one of the factors will have a description and a scale, for example, “Company's Certifications” score will be higher based on how many relevant certifications company has related to the relevant industry and it can be computed automatically by the digital economy platform. The same will be applicable for the rest of the factors.

(F) for Finance-ability of the Transaction. The attribute F measures various factors to determine, for example, the credit worthiness of a user for global trade financing or open account credit as well as a financial services institution's ability to provide compliant and robust services within particular markets. Borrower F-factors 134 include various factors such as balance sheet and income statement measures such as liquidity, cash flow, debt service coverage, inventory turnover and receivables aging, levels of business concentration related to industries, geography, product lines, customers and suppliers, and more.

The (I) stands for Insurability of the Transaction. The attribute (I) provides an objective measure for risk evaluation and pricing based on several insurance related factors known as I-factors 136 including such as: product type and value, shipment method, warranties, packing, point of loading/discharge, country risk rankings, number of transshipments, transit and storage times, extent of insurance coverage at shipment events, and/or the like.

The (L) stands for Logistics Reliability and Dependability. The attribute (L) measures the ability to deliver shipments on time on a regular basis including the resilience to meet future demand. The relevant logistics reliability and dependability factors, such as L-factors 138, which may include delivery performance based on contract, forecasted and actual measurements, level, and frequency of demurrage charges, average shipment times, percent of damaged shipments, level of dynamic monitoring and tracking of shipments from shelf to shelf, etc.

The (In) stands for Integration. The attribute (In) considers supply chain and logistics integration related factors, such as In-factors 140, which may include the ease of integrating a trade partner into the supply chain, the cost of integrating a trade partner, and the length of time to achieve integration.

The system 100 (offered through the digital economy platform) will use sophisticated Artificial Intelligence driven algorithms to harness this high-quality data to automatically derive an AxioScore™ 150 that represents an aggregation of performance attribute metrics (e.g., the 5-key “QFILI” attributes).

AxioScore™ 150 is a multi-dimensional scoring to objectively measure business performance and underlying risks, represented on a specific scale, for example from Excellent to Poor.

AxioScore™ uses validated, assimilated, aggregated, and refined transactional big data and is measured with “Excellent” being the most attractive score, signaling the overall commercial viability of a potential product or service provider.

AxioScore™ can also be sorted by the data reliability indicated in terms of a “5-Star Rating” which reflects the volume of data and number of data validations creating the score 150. An increased volume of data and number of data validations may enhance the reliability of the score 150.

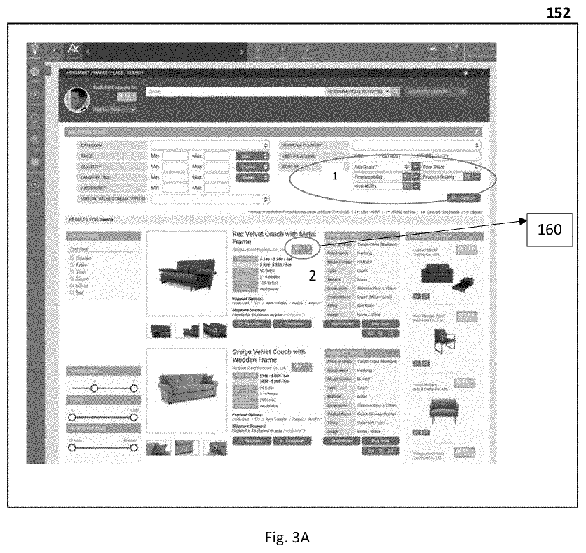

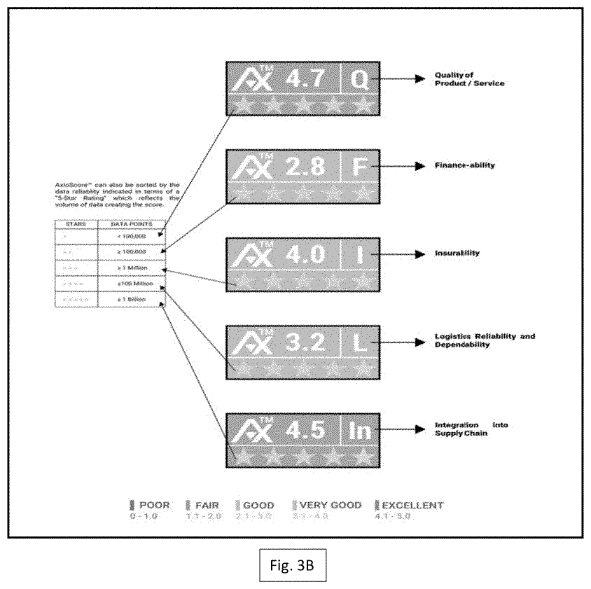

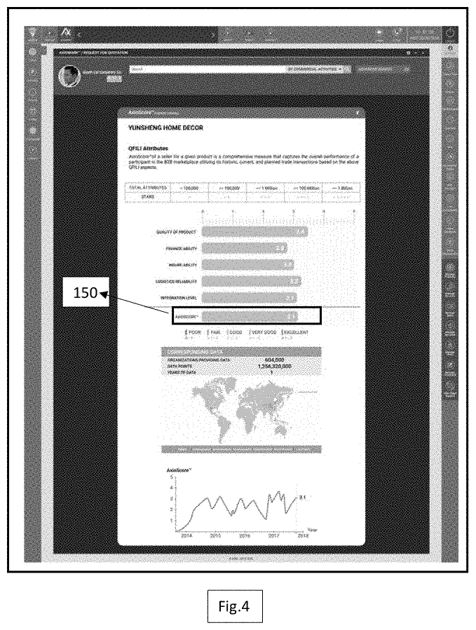

FIG. 3A generally illustrates an interface 152, such as a graphical user interface, which may be embodied as an application or other software and displayed on a known computing device, such as a smartphone, tablet, desktop computer, laptop computer, and/or the like, for using the AxioScore™ 150 in a manner described herein.

FIG. 3A also shows a sample of an interface 152 using the AxioScore™ 150 for advanced search and sorting of a product or service. With reference to Region 1 of FIG. 3A, the various products and services being searched may be sorted and displayed based on the prioritization of performance metric attributes (e.g., AxioScore™ Attributes, such as QFILI attributes) as part of the sorting functionality. For example, if a user searches for a product/service, a list of 1,000 companies/service providers may be returned and it may not be possible to fit all to appear on one screen. However, with this multi-dimensional sorting using AxioScore™ Attributes, the list of search results can be shown in a “priority display” (those with the highest AxioScore™ 150 displayed first), with, for example, 120 having a very high AxioScore™ 150. A user may set the priority for any relevant QFILI attribute (Q, F, I, L, and/or In) to better match the user's requirements. If the user chooses “Finance-ability” as priority number one (as shown in the example of FIG. 3A, companies/service providers with the highest “Finance-ability” rating will be listed first.

For example, with reference to Region 2 of FIG. 3A, the Supplier and Product are shown with an AxioScore™ 150 based on the sorting selected at Region 1. In one aspect, the default for the sorting will show the AxioScore™ 150 based on Quality of Products and Services, and then it may change according to sorting preferences by an end user. However, in another aspect, the default may be set to other QFILI attributes.

FIG. 3B shows the AxioScore™ 150 from different QFILI attributes perspective. For example, for the product or company in the example of FIG. 3B, selecting “Finance-ability” as priority one at Region 1 of FIG. 3A would show the AxioScore™ with 2.8, and may display the letter “F” to indicate that the sorting is based on Finance-ability. A rating between 2.1 and 3 would indicate that the supplier selected has a “Good” score 150 from a finance perspective. In this example, selecting Insurability as Priority One at Region 1 of FIG. 3A would show the score as 4.0. A rating between 3.1 and 4 would indicate that the supplier has a “Very Good” score 150 from an insurance perspective. Similarly selecting other QFILI attributes would provide sorting and indications based on the selected attribute. Scores between 0 and 1 are “Poor”; Scores between 1.1 and 2.0 are “Fair”; Scores between 2.1 and 3.0 are “Good”; Scores between 3.1 and 4.0 are “Very Good”; Scores between 4.1 and 5.0 are “Excellent.”

FIG. 3B generally illustrates one example of scores 150 for various attributes according to the principles of the present disclosure. AxioScore™ 150 is indicated by a measure with single digit precision on a numerical scale of 1 to 5 separated by an indicator for the Attribute. For example, in the FIG. 3B, the Supplier of the Product has an AxioScore™ of 4.7 for Quality of

Products and Services Attribute with a four-star rating. The four-star rating in this example indicates the volume of underlying data that comprises more than 100 million data points.

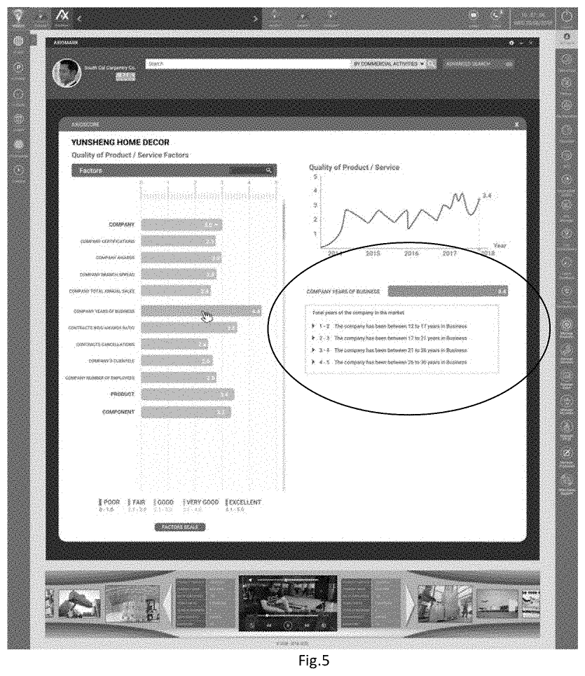

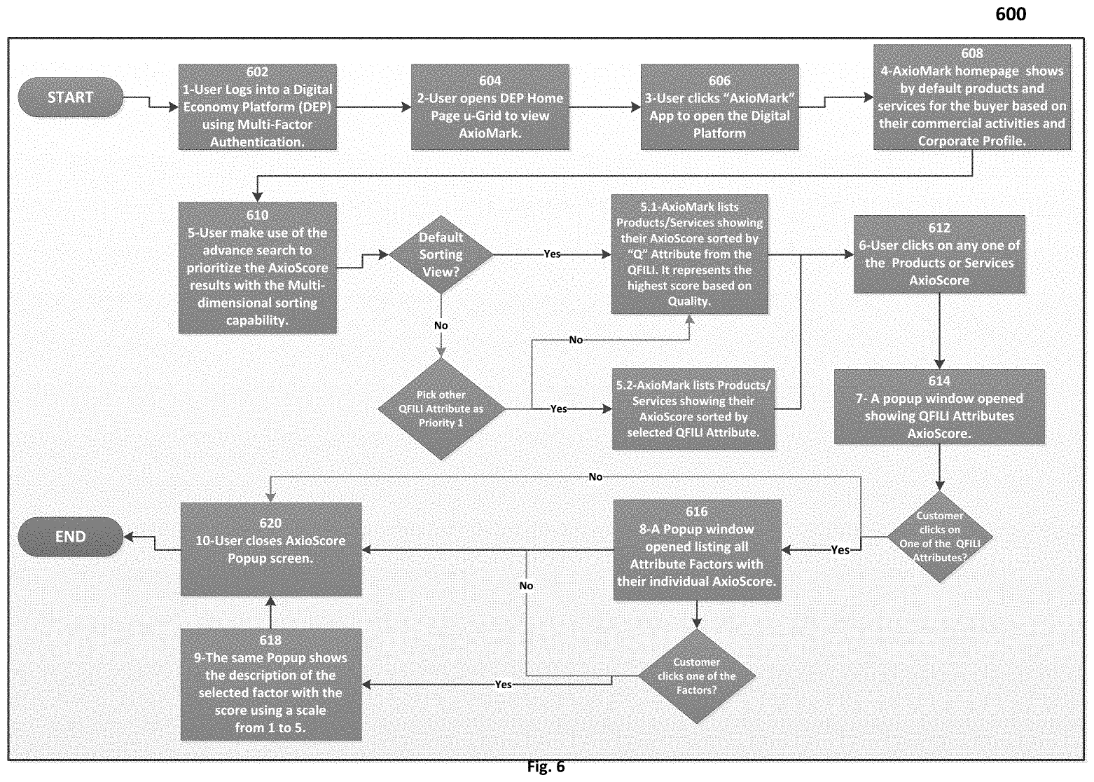

As shown in FIG. 3A and Region 2, the score 150 is displayed as a button 160. Clicking or otherwise selecting the button 160 may open a new display, illustrated for example in FIG. 4.

Region 1 may include further sorting aspects. For example, the user may select a minimum star rating by which to limit the results. In the example of FIG. 3A, the user has selected a 4 star rating (in one example including 100 million data points). A higher star rating includes relatively more data points, and a lower star rating includes relatively fewer data points. Accordingly, the user may be able to tailor results depending on the degree of reliability of the score 150 that is desired. It will be appreciated that the lower star rating selected, the more results will be displayed. The user can therefore begin with a higher star rating selected, and can lower the star rating if the number of results is insufficient in the view of the user.

The interface 152 may further include additional search aspects for tailoring the search. For example, the type of product may be searched by a character string in a search box. Alternatively, the types of products may be selectable based on predefined categories, such as couch, table, chair, and/or the like. The results may be limited by selecting a specific AxioScore™ 150 value. Results may be limited by price, delivery time, and/or the like. It will be appreciated that additional aspects may be selected to further filter the search results. In each case, the AxioScore™ 150 that has been automatically determined by the digital economy platform will indicate to the user an objective score that meets the user's desired attributes.

FIG. 4 generally illustrates another interface 162 for the digital economy platform using scored data according to the principles of the present disclosure. FIG. 4 reflects information generated after selecting a Supplier or Product, for example by selecting the button 160 on interface 152. Total AxioScore™ 150, the QFILI portions of the AxioScore™ 150, and the number of historical data points and entity validations used to generate this AxioScore™ 150. For example, in FIG. 4, the total AxioScore™ 150 of the Supplier is 3.1 based on over 1.2 billion data points gathered from real-time commercial transactions, validated by 604,000 entities/organizations during the past 1 year.

In the example of FIG. 4, the Q portion of the score 150 is 3.4, the F portion is 2.8, the I portion is 3.0, the L portion is 3.2, and the In portion is 3.1. FIG. 4 also provides a geographic location of the supplier, as well as a historical record of the overall score 150 over the period of time in which the score 150 has been generated, thereby indicating to the user whether the supplier's performance has been consistent over time and whether or not the supplier's performance is trending in a certain direction. Specific attributes of the QFILI portions of the score 150 may be further provided to the user by selecting on of the attributes, for example by selecting the name or the bar indicating the score, with detail being provided at an interface 164 similar to that illustrated in FIG. 5.

FIG. 5 generally illustrates another interface 164 for the digital economy platform using scored data according to the principles of the present disclosure. FIG. 5, in this example, reflects the Quality of Products and Services Factors (Q-factors) of the Quality Attribute of the QFILI categories. These factor the performance scoring for the Company, the Product or Services and the Components of the products. Each one of the Factors will have a score, a description, and a scale that will show how the scoring has been defined. For example, “Company's years in Business” has a higher AxioScore™ of 4.4 and it's because the company has more than 25 years doing this business. Selecting one of the factors may display further detail and the scale for objectively determining the score. In this example, by selecting “Company Years in Business” on the left, the scale used is displayed, indicating how many years would result in which score for this attribute. The same may be applicable for the rest of the factors. Similar to FIG. 4, a historical graph with the specific Quality for Products and Services portion of the AxioScore™ 150 for the past 5 years is displayed in this example. Of course, other periods of time may be shown.

Turning now to FIG. 6, a flowchart is provided that illustrates a user's (e.g., a participant's) interaction with the digital economy platform. FIG. 6 illustrates one example of how users of the system may view the AxioScore™ 150 of the suppliers, buyer, sellers, and/or Logistics Service Providers (LSP) using a digital economy platform. The user may be a buyer or a seller.

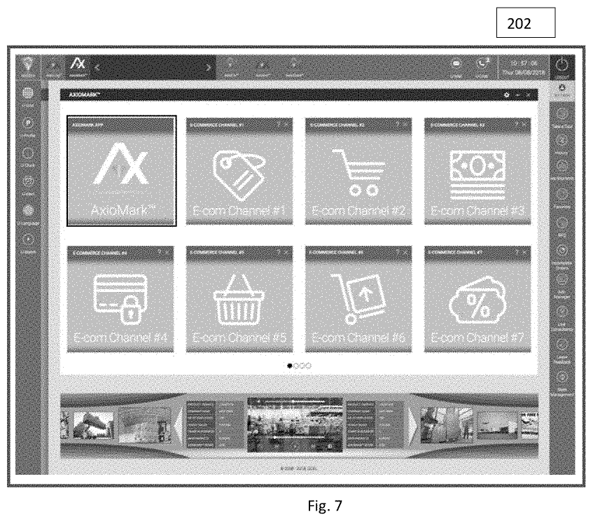

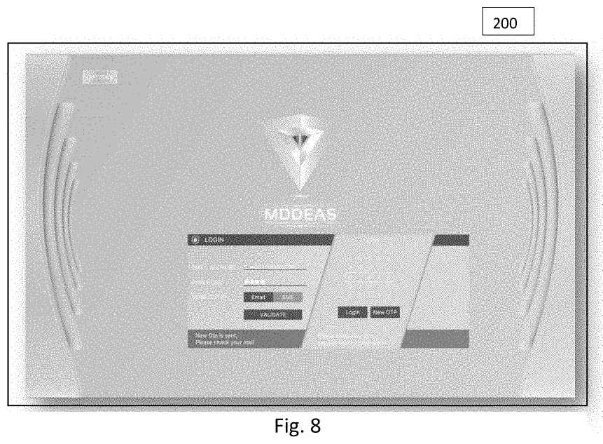

Turning now to a method 600 illustrated in FIG. 6 from a buyer's perspective, at step 602, a buyer logs into an account associated with the digital economy platform using multi-factor authentication. In some implementations, the digital economy platform may be a commercial platform, an e-commerce platform, and/or the like. An example of a login screen 200 is shown in FIG. 8. At step 604, the user opens the digital economy platform home page U-grid to view AxioMark® 202 (FIG. 7), an e-commerce platform. The buyer launches AxioMark® Dimension to access an e-commerce application. At step 606, the buyer clicks on AxioMark® to open the e-commerce platform (FIG. 3). The buyer launches the e-commerce application that provides an interface to conduct trading, seeing their AxioScore™ and the AxioScores™ of their Suppliers and LSPs.

At step 608, the AxioMark® homepage (FIG. 3) shows, by default, products and services for the buyer based on their historical, current, and planned commercial activities and corporate profile. The buyer may click Advanced search and sort and select AxioScore attributes to prioritize search results based on QFILI Attributes. For example, selecting F as priority 1 will display the products and suppliers with the highest score in Finance-ability. At step 610, the buyer makes use of the advanced search to prioritize the AxioScore™ results with the multi-dimensional sorting capability. The default sorting view may be used. If so, AxioMark® lists products and services showing AxioScore™ sorted by Q attribute from the QFILL This represents the highest score based on Quality. If a non-default sorting view is used, the buyer picks other QFILI attributes as priority 1, and the results will list products/services showing the AxioScore™ sorted by the selected QFILI attribute.

At step 612, the buyer clicks on any of the products or supplier's AxioScore™. The buyer clicks one of the AxioScore™ to view what makes up the AxioScore™ based on QFILI attributes. The AxioScore™ may show different color gradients depending on the scale as shown in FIG. 3B.

At step 614, a pop-up window opens showing QFILI attributes AxioScore™, as shown in FIG. 4. AxioMark® opens a popup screen with QFILI attributes score, and each attribute shows a name and its respective AxioScore™. In the same popup, the buyer is able to view: QFILI attributes AxioScore™ for the item selected, star rating values, a geographical area, and historical AxioScore™ values for the past five years.

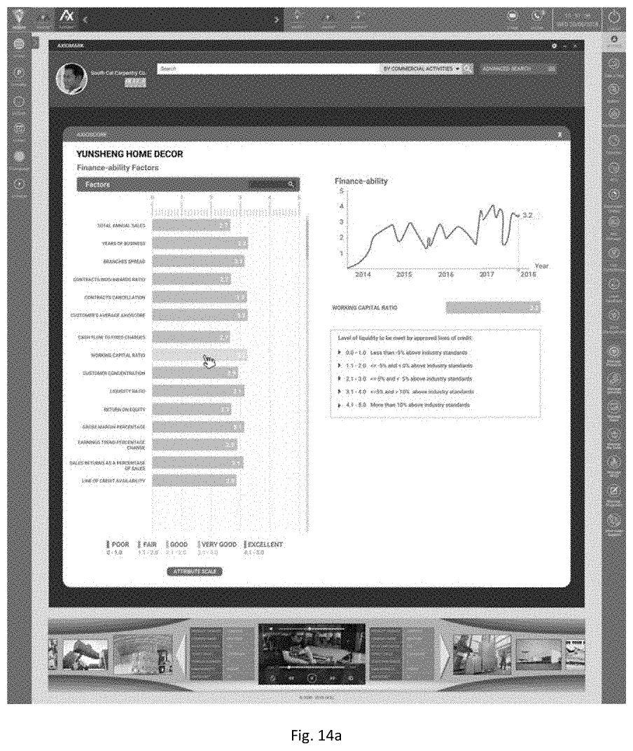

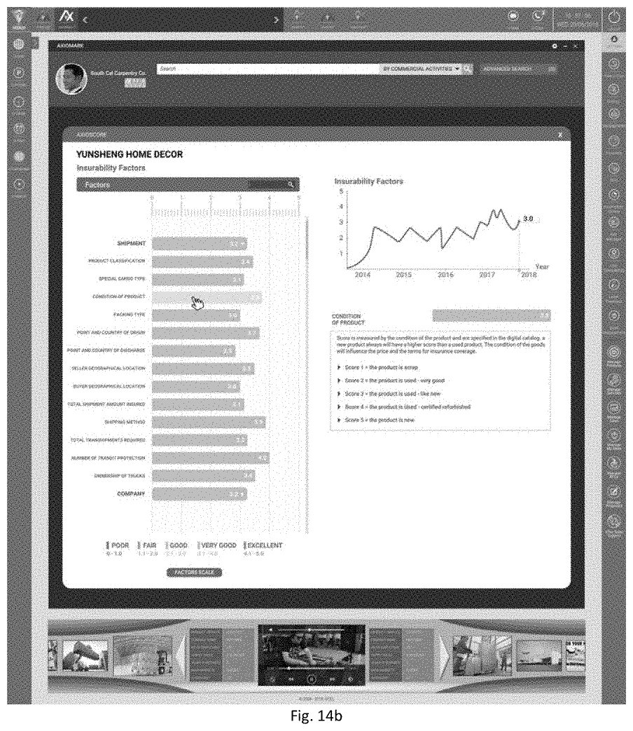

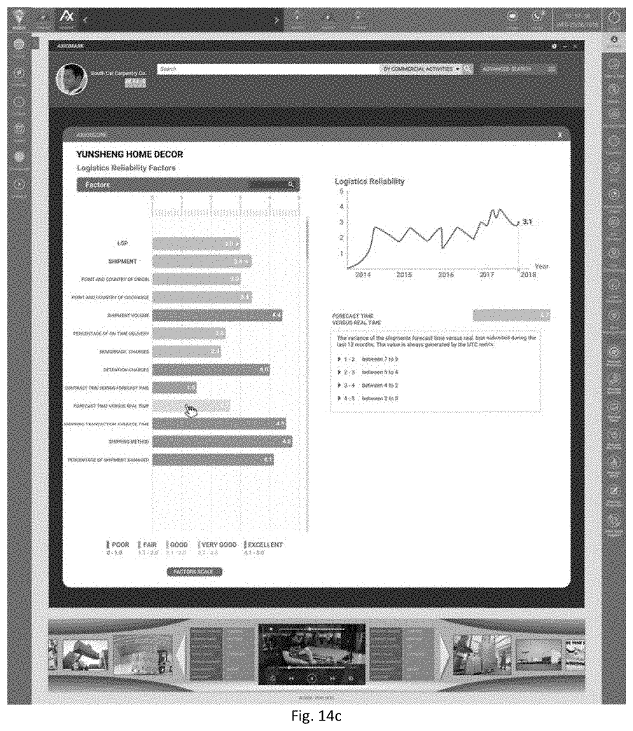

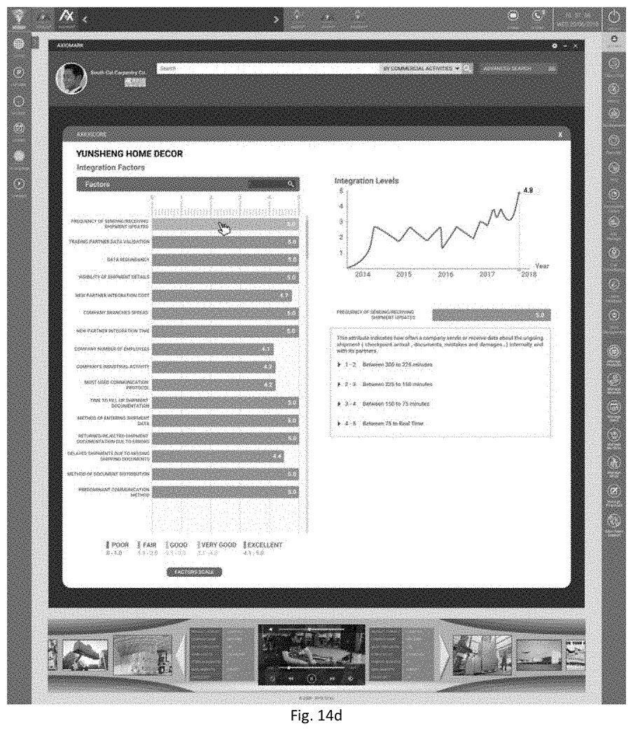

At step 616, a popup window opens listing all attribute factors with their individual AxioScore™. When the buyer clicks on one of the attributes, for example Q, AxioMark® opens a new popup with the factors of Q (Quality of Products or Services). FIGS. 14A-D illustrate an example of a popup showing different attributes.

At step 618, the same popup displays the description of the selected factor with the score using a scale, as shown in FIG. 5. The buyer clicks any one of the factors, and it shows the name, score, description, and the score's scale range.

At step 620, the user closes the AxioScore™ factors popup screen.

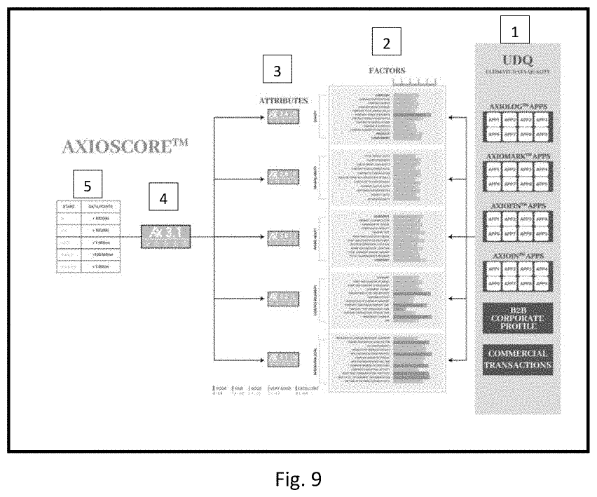

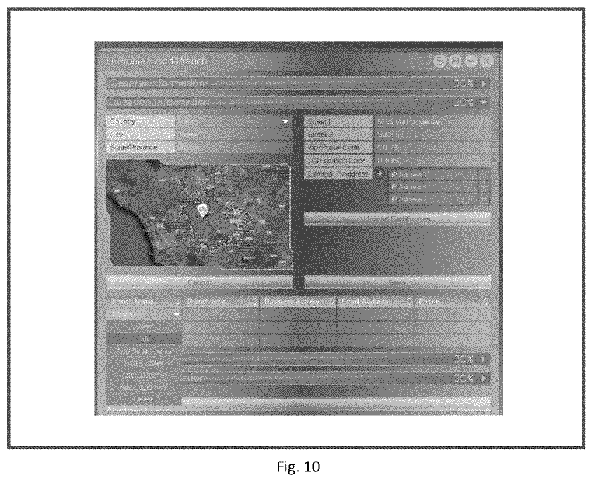

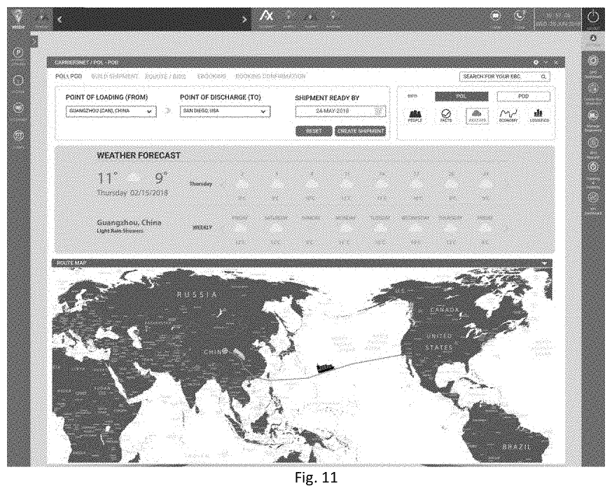

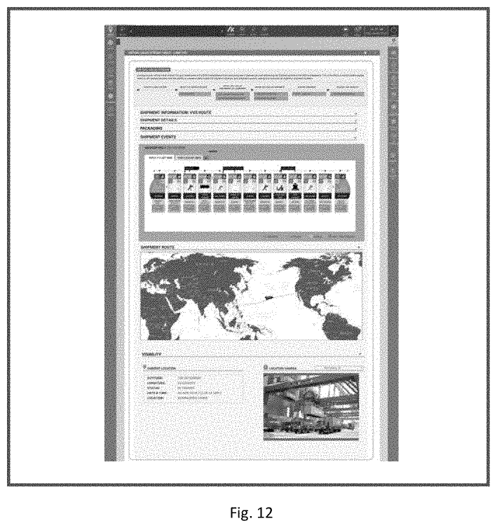

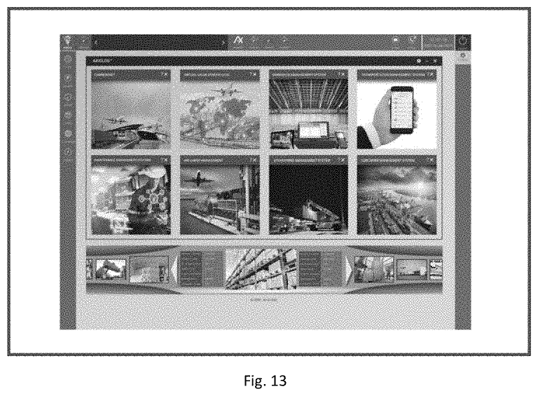

Turning now to FIG. 9, an AxioScore™ sample representation and its logical decomposition is shown. At area 1 of FIG. 9, Ultimate Data Quality (UDQ) is generated from MDDEAS® Applications. Buyers, Sellers, Logistics Service Providers, Financial Institutions and Insurers log into MDDEAS® platform, adding their Corporate Profile Information (FIG. 10) and documentation using a variety of Applications and performing business activities. All of this real-time data may be used to generate the UDQ. FIGS. 11, 12, and 13 show examples of Applications. FIG. 11 illustrates a U-grid of AxioLog® Applications. FIG. 12 illustrates a Virtual Value Stream App. FIG. 13 illustrates a CarriersNet App.

At area 2 of FIG. 9, factors in each performance area are automatically calculated from the relevant UDQ—Data Elements. UDQ—Data elements are generated from real-life actions of participants conducting business transactions through usage of commercial applications. Each cluster of relevant entity area factors are automatically aggregated to calculate appropriate performance attribute metrics, as an example, grouped into 5 QFILI Attributes; Quality of Products and Services, Finance-ability, Insure-ability, Logistic Reliability and Integration Level. Each factor will have a data score based on a scale and their weightings in the computation of AxioScore™ Attributes will be automatically calibrated and refined using Artificial Intelligence and predictive analytics and statistical techniques and modeling.

At area 3 of FIG. 9, Each QFILI Attribute will have an AxioScore™. Each QFILI Attribute is computed from the weighted aggregation of their relevant Factors and the weights being appropriately calibrated to arrive at AxioScore™ Attributes that are true indicators of entity performance and risk of an entity in a performance area they represent.

At area 4 of FIG. 9, Total AxioScore™ is shown, resulting from aggregation of weighted averages of individual performance area attributes such as QFILI Attributes. Total AxioScore™ is generated from performance attributes, such as QFILI Attributes, using certain algorithms.

At area 5 of FIG. 9, AxioScore™ Stars rating is shown. The product and service search results can also be sorted by the data reliability indicated in terms of a “5-Star Rating” which reflects the volume of data and number of data validations creating the AxioScore™ Start Rating. Having many stars will increase the trust of the participant because the volume of underlying data in the computation of the AxioScores™ in the system is bigger than others.

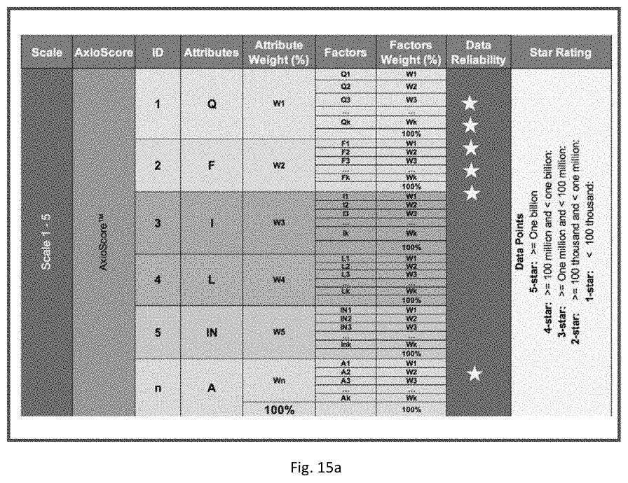

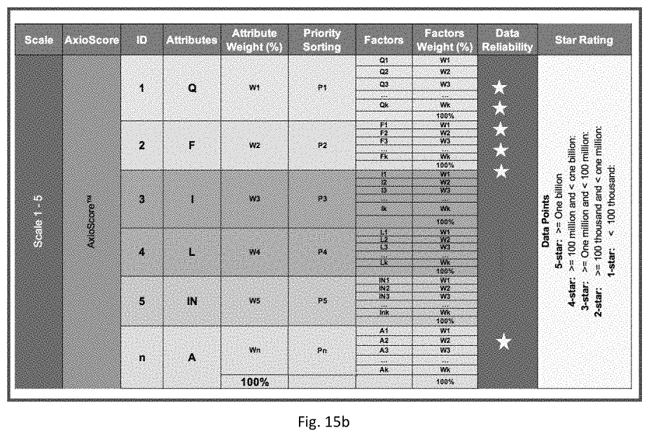

With reference to FIGS. 15A and 15B, a high-level computational model for the aggregated AxioScore™ and attribute level AxioScores™ is shown. AxioScore™ is an aggregated score of business performance and risk profile of a business based on a weighted average of attribute scores whose priority is determined by the industry standards.

AxioScore™ consists of several business performance and risk related attributes, each one of which represents one aspect of business performance that is of interest to the trading partners based on their industry and their business functional role. For example, this may include online e-commerce buyers and sellers of products and services, such as Logistics Service Providers (LSPs), Financial Institutions such as Banks and Lending Organizations, and Insurance Service Providers.

As shown in FIG. 15, these attributes can be one or more depending upon the industry affiliation and the intended use of the AxioScores™. AxioScores™ are used in a multi-dimensional sorting mechanism to organize the search results in a “priority display” based on the individual attributes. The multi-dimensional sorting of search results will be based on the aggregate weighted average of Attribute AxioScores™ where the weights are determined by the priority assigned to individual attribute scores based on the relevant industry standards.

For example, if the priority assignments among QFILI attributes explained below, are as follows; Quality (Q) as priority one (P1), Finance-ability (F) as priority two (P2), Insure-ability (P3) as priority three (P3), Logistics Reliability and Dependability (L) as priority four (P4), and Integration into supply chain (In) as priority five (P5), the attribute with the highest priority P1 will get the maximum weight and the lowest priority attribute will get the lowest weight with other attributes getting appropriate weights in that order. The distribution of these weights among the various attributes will be based on the industry standards. Each attribute is driven by several underlying factors and individual AxioScore™ attribute is calculated based on a weighted average of contributing factors.

Based on the above logic, the mathematical formulation of Aggregate AxioScore™ S is given by equation below:

$$AxioScore S = {\sum }_{i = 1}^{n} ( ( A i = {\sum }_{j = 1}^{k} ( {F}_{j} \cdot {W}_{j} ) ) . {W}_{i} ( Pi ) )$$

Any Attribute represented by Ai, is a weighted average of individual factors represented by Fj.Wj where Fj.Wj is a product of a measure of factor and its corresponding weight in the calculation. The weight of each Attribute is a function of its priority ranking denoted by Wi(Pi). The aggregated AxioScore™ for multi-dimensional sorting is dynamically calculated. For example, if Finance-ability(F) is assigned Priority 1, it will get the highest standard weight for the AxioScore™ attribute denoted by “F” and if Integration (In) is assigned the lowest Priority 5, it will get the lowest standard weight for the AxioScore™ attribute denoted by “In”.

### Statistical Techniques and Technologies Applied

1. Selection of business performance and risk Attributes (Ai).

2. Identification of relevant Factors (Fj) that are directly related and contributing to each individual Attribute.

Sensitivity analysis will be used at two levels over a universe of business performance measures in the identification and selection of individual attributes and over a universe of underlying factors in the identification and selection of relevant factors. The sensitivity analysis is a technique used to determine how independent variable values (Factors, and Attribute Scores) will impact a particular dependent variable (Attribute Score, and AxioScore™) under a given set of assumptions. It helps in analyzing how sensitive the output is, by the changes in one input while keeping the other inputs constant. This analysis will be performed by each industry and individual sectors within an industry and by business function or role.

3. Identification of Weights (Wi) of Attributes in the calculation of aggregated AxioScore™ used in multi-dimensional sorting will be based on industry standards and appropriate weights will be assigned to the relevant attribute scores based on their prioritization in terms of Pl, P2, P3, P4, and P5.

4. Identification of Weights (Wj) of each factor in the calculation of Attribute.

The weights among the Attribute Scores in the calculation of AxioScore™ and the weights among the Factors in the calculation of AxioScore™ Attribute Scores will be determined using correlation analysis between Aggregated AxioScore™ and its component Attribute Scores based on the industry standard priorities and between the Attribute AxioScores™ and its Factors. Such analysis will be performed by type of industry or by each individual sector within industry, or by business function or the role of a participant.

Correlation analysis will be used to determine the strength of each weight at both the levels. Correlation is a statistical technique that can show whether and how strongly pairs of variables are related. For example, in the calculation of Quality Attribute Score, correlation analysis can determine the appropriate distribution of weights among factors relating to the strength of company profile, quality aspects of their products and services, and also the quality aspects of the relevant product components and other dependent services. This analysis will be performed for each industry or for individual sectors within an industry.

5. Predictive Analytics and Predictive Modeling to ensure AxioScore™ is a true business performance and risk measure.

While the historical business transactions and participants' related data will be used in the identification and calculation of Attribute Scores and AxioScores™, it is desired that the AxioScore™ at the attribute level as well as at the aggregate level be a true and reliable indicator of future business performance and risk behavior of a company. This is accomplished by building an Artificial Intelligence driven Predictive Forecasting and Self-learning Model using data mining, Big Data Analytics, statistics and modeling to make predictions about future outcomes. In other words, historical data defines a set of parameters, which computers can then use to determine what the business behavior/responses might be in the future. The priorities of individual attribute AxioScores™ for each industry and individual sectors within industry will be determined based on the industry standards and how well the attribute level and aggregated level AxioScores™ are able to predict the right behavior.

Predictive analytics is an area of statistics that deals with extracting information from data and using it to predict trends and behavior patterns. Predictive analytics statistical techniques include data mining looking for patterns in large amounts of data, machine learning which is a form of artificial intelligence where machines are designed to learn and forecast future behavior using Artificial Intelligence, and deep learning algorithms.

The above statistical techniques and predictive analytics will be used on the real-time business transactional big data in the computation of Attribute level and Aggregated level AxioScores™ and constant validation and refinements of relevant attribute priorities, factors and weights to transform AxioScores™ as valid indicators of business performance and risk behavior.

These models will be built for each industry and for each individual sector within an industry as appropriate and will be based on the business function and role, and the intended usage of the AxioScores™.

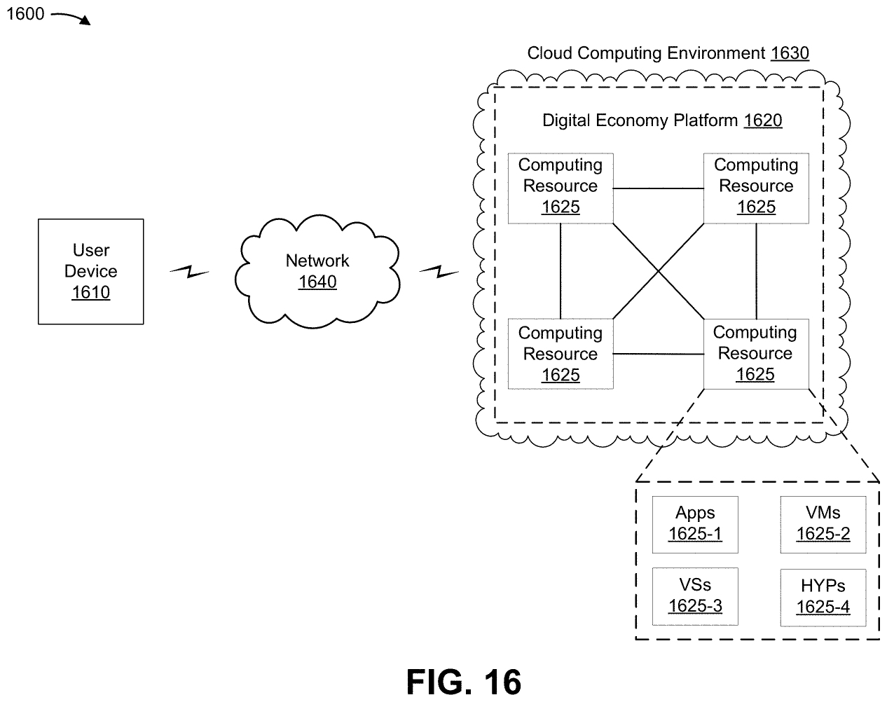

FIG. 16 is a diagram of an example environment 1600 in which systems and/or methods, described herein, may be implemented. As shown in FIG. 16, environment 1600 may include a user device 1610, a digital economy platform 1620 hosted by a cloud computing environment 1630, and/or a network 1640. Devices of environment 1600 may interconnect via wired connections, wireless connections, or a combination of wired and wireless connections.

User device 1610 includes one or more devices capable of receiving, generating, storing, processing, and/or providing information, such as information described herein. For example, user device 1610 may include a communication and/or computing device, such as a phone (e.g., a mobile phone, such as a smartphone, a radiotelephone, etc.), a laptop computer, a tablet computer, a handheld computer, a gaming device, a wearable communication device (e.g., a smart wristwatch, a pair of smart eyeglasses, etc.), or a similar type of device.

Digital economy platform 1620 includes one or more devices capable of receiving, generating, storing, processing, and/or providing information, such as information described herein. For example, digital economy platform 1620 may include a server device (e.g., a host server, a web server, an application server, a database server, and/or the like), a data center device, or a similar device.

In some implementations, digital economy platform 1620 may receive information, such as profile information, commercial activity information, documentation information, and/or the like. The information may be associated with an entity and/or one or more other entities that are engaging in trade with the entity. In some implementations, digital economy platform 1620 may receive the information from user device 1610. In some implementations, digital economy platform 1620 may obtain the information from one or more data storage devices. For example, digital economy platform 1620 may obtain the information via a communication interface, such as an application programming interface (API) or another type of interface.

In some implementations, digital economy platform 1620 may be part of a system that includes a set of cloud platforms. For example, digital economy platform 1620 may include or be part of a system that includes an e-commerce platform, an e-logistics platform, an e-finance platform, an e-insurance platform, a scoring platform, and/or the like.

In some implementations, digital economy platform 1620 may include a data intake module, a standardization module, a filtering module, a first scoring module, a second scoring module driven by machine learning, and/or the like. In some implementations, digital economy platform 1620 may identify one or more universal data elements using the data input module. Additionally, or alternatively, digital economy platform 1620 may receive information (e.g., profile information, commercial activity information, documentation information, and/or the like) using the data input module. Additionally, or alternatively, digital economy platform 1620 may standardize input data using the standardization module. Additionally, or alternatively, digital economy platform 1620 may filter standardized data using the filtering module. Additionally, or alternatively, digital economy platform 1620 may identify Ultimate Data Quality (UDQ) (e.g., based on data being validated by a validation module of digital economy platform 1620, a validation service external to digital economy platform 1620, and/or the like). Additionally, or alternatively, digital economy platform 1620 may generate performance attribute metric values using the first scoring module. Additionally, or alternatively, digital economy platform 1620 may generate an overall performance score using the second scoring module.

In some implementations, digital economy platform 1620 may host a website that user device 1610 utilizes to access one or more applications described herein (e.g., applications 102, application 1625, and/or the like). In some implementations, digital economy platform 1620 may support the website used by user device 1610. For example, the website may be hosted by another device, such as an e-commerce platform or another server device and digital economy platform 1620 may provide the other device with an overall performance score, with a recommendation associated with the overall performance score, and/or the like.

In some implementations, as shown, digital economy platform 1620 may be hosted in cloud computing environment 1630. Notably, while implementations described herein describe digital economy platform 1620 as being hosted in cloud computing environment 1630, in some implementations, digital economy platform 1620 might not be cloud-based (i.e., may be implemented outside of a cloud computing environment) or might be partially cloud-based.

Cloud computing environment 1630 includes an environment that hosts digital economy platform 1620. Cloud computing environment 1630 may provide computation, software, data access, storage, and/or other services that do not require end-user knowledge of a physical location and configuration of system(s) and/or device(s) that host digital economy platform 1620. As shown, cloud computing environment 1630 may include a group of computing resource 1625 (referred to collectively as “computing resources 1625” and individually as “computing resource 1625”).

Computing resource 1625 includes one or more personal computers, workstation computers, server devices, or another type of computation and/or communication device. In some implementations, computing resource 1625 may host digital economy platform 1620. The cloud resources may include compute instances executing in computing resource 1625, storage devices provided in computing resource 1625, data transfer devices provided by computing resource 1625, etc. In some implementations, computing resource 1625 may communicate with other computing resources 1625 via wired connections, wireless connections, or a combination of wired and wireless connections.

As further shown in FIG. 16, computing resource 1625 may include a group of cloud resources, such as one or more applications (“APPs”) 1625-1, one or more virtual machines (“VMs”) 1625-2, virtualized storage (“VSs”) 1625-3, one or more hypervisors (“HYPs”) 1625-4, or the like.

Application 1625-1 includes one or more software applications that may be provided to or accessed by user device 1610. Application 1625-1 may eliminate a need to install and execute the software applications on user device 1610. For example, application 1625-1 may include software associated with digital economy platform 1620 and/or any other software capable of being provided via cloud computing environment 1630. In some implementations, one application 1625-1 may send/receive information to/from one or more other applications 1625-1, via virtual machine 1625-2. In some implementations, application 1625-1 may include applications 102. In some implementations, application 1625-1 may include an application capable of interacting with applications 102.

Virtual machine 1625-2 includes a software implementation of a machine (e.g., a computer) that executes programs like a physical machine. Virtual machine 1625-2 may be either a system virtual machine or a process virtual machine, depending upon use and degree of correspondence to any real machine by virtual machine 1625-2. A system virtual machine may provide a complete system platform that supports execution of a complete operating system (“OS”). A process virtual machine may execute a single program, and may support a single process. In some implementations, virtual machine 1625-2 may execute on behalf of a user (e.g., user device 1610), and may manage infrastructure of cloud computing environment 1630, such as data management, synchronization, or long-duration data transfers.

Virtualized storage 1625-3 includes one or more storage systems and/or one or more devices that use virtualization techniques within the storage systems or devices of computing resource 1625. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1625-4 provides hardware virtualization techniques that allow multiple operating systems (e.g., “guest operating systems”) to execute concurrently on a host computer, such as computing resource 1625. Hypervisor 1625-4 may present a virtual operating platform to the guest operating systems, and may manage the execution of the guest operating systems. Multiple instances of a variety of operating systems may share virtualized hardware resources.

Network 1640 includes one or more wired and/or wireless networks. For example, network 1640 may include a cellular network (e.g., a fifth generation (5G) network, a fourth generation (4G) network, such as a long-term evolution (LTE) network, a third generation (3G) network, a code division multiple access (CDMA) network, another type of advanced generated network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 16 are provided as an example. In practice, there may be additional devices and/or networks, fewer devices and/or networks, different devices and/or networks, or differently arranged devices and/or networks than those shown in FIG. 16. Furthermore, two or more devices shown in FIG. 16 may be implemented within a single device, or a single device shown in FIG. 16 may be implemented as multiple, distributed devices. Additionally, or alternatively, a set of devices (e.g., one or more devices) of environment 1600 may perform one or more functions described as being performed by another set of devices of environment 1600.

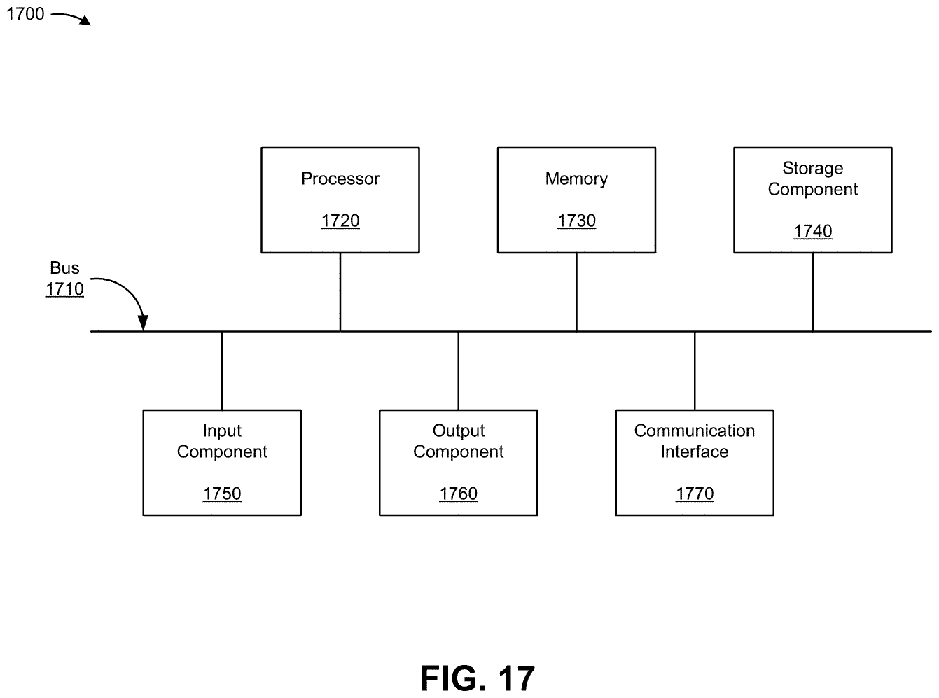

FIG. 17 is a diagram of example components of a device 1700. Device 1700 may correspond to user device 1610 and/or digital economy platform 1620. In some implementations, user device 1610 and/or digital economy platform 1620 may include one or more devices 1700 and/or one or more components of device 1700. As shown in FIG. 17, device 1700 may include a bus 1710, a processor 1720, a memory 1730, a storage component 1740, an input component 1750, an output component 1760, and a communication interface 1770.

Bus 1710 includes a component that permits communication among the components of device 1700. Processor 1720 is implemented in hardware, firmware, or a combination of hardware and software. Processor 1720 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing component. In some implementations, processor 1720 includes one or more processors capable of being programmed to perform a function. Memory 1730 includes a random access memory (RAM), a read only memory (ROM), and/or another type of dynamic or static storage device (e.g., a flash memory, a magnetic memory, and/or an optical memory) that stores information and/or instructions for use by processor 1720.

Storage component 1740 stores information and/or software related to the operation and use of device 1700. For example, storage component 1740 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 1750 includes a component that permits device 1700 to receive information, such as via user input (e.g., a touch screen display, a keyboard, a keypad, a mouse, a button, a switch, and/or a microphone). Additionally, or alternatively, input component 1750 may include a sensor for sensing information (e.g., a global positioning system (GPS) component, an accelerometer, a gyroscope, and/or an actuator). Output component 1760 includes a component that provides output information from device 1700 (e.g., a display, a speaker, and/or one or more light-emitting diodes (LEDs)).

Communication interface 1770 includes a transceiver-like component (e.g., a transceiver and/or a separate receiver and transmitter) that enables device 1700 to communicate with other devices, such as via a wired connection, a wireless connection, or a combination of wired and wireless connections. Communication interface 1770 may permit device 1700 to receive information from another device and/or provide information to another device. For example, communication interface 1770 may include an Ethernet interface, an optical interface, a coaxial interface, an infrared interface, a radio frequency (RF) interface, a universal serial bus (USB) interface, a Wi-Fi interface, a cellular network interface, or the like.

Device 1700 may perform one or more processes described herein. Device 1700 may perform these processes based on processor 1720 executing software instructions stored by a non-transitory computer-readable medium, such as memory 1730 and/or storage component 1740. A computer-readable medium is defined herein as a non-transitory memory device. A memory device includes memory space within a single physical storage device or memory space spread across multiple physical storage devices.

Software instructions may be read into memory 1730 and/or storage component 1740 from another computer-readable medium or from another device via communication interface 1770. When executed, software instructions stored in memory 1730 and/or storage component 1740 may cause processor 1720 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 17 are provided as an example. In practice, device 1700 may include additional components, fewer components, different components, or differently arranged components than those shown in FIG. 17. Additionally, or alternatively, a set of components (e.g., one or more components) of device 1700 may perform one or more functions described as being performed by another set of components of device 1700.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method, comprising:
identifying, by a device, one or more universal data elements;
receiving, by the device, profile information for an entity, the entity being associated with the one or more universal data elements;
receiving, by the device, commercial activity information and documentation information associated with the entity;
identifying, by the device, Ultimate Data Quality (UDQ) using the one or more universal data elements, the profile information, the commercial activity information, and the documentation information;
automatically generating, by the device, performance attribute metrics associated with the entity based on the UDQ and one or more performance factors associated with the entity; and
automatically generating, by the device, an overall performance score for the entity using the performance attribute metrics.

2. The method of claim 1, wherein the one or more performance factors include at least one of:
a quality factor,
a finance factor,
an insurability factor,
a logistics reliability and dependability factor, or
an integration factor.

3. The method of claim 1, wherein the overall performance score includes a plurality of component portions corresponding to each of the performance attribute metrics.

4. The method of claim 1, further comprising providing, for display, an interface for identifying a desired item based on the overall performance score.

5. The method of claim 4, further comprising prioritizing the desired item based on the overall performance score.

6. The method of claim 4, further comprising prioritizing the desired item based on a component portion of the overall performance score.

7. The method of claim 4, further comprising prioritizing the desired item based on the performance attribute score.

8. The method of claim 4, further comprising causing the overall performance score, which corresponds to the desired item, to be displayed.

9. The method of claim 1, further comprising receiving an input corresponding to a selection of a component portion of the overall performance score; and displaying a breakdown of factors associated with the component portion of the overall performance score.

10. The method of claim 1, further comprising displaying a quantity of universal data elements associated with the overall performance score.

11. The method of claim 1, displaying a number of years that data has been collected.

12. The method of claim 1, further comprising weighting the performance attribute metrics and corresponding factors and using artificial intelligence to generate the overall performance score.

13. The method of claim 1, further comprising comparing performance data associated with actual performance with the generated overall performance score; determining gaps there between; and automatically calibrating and adjusting weights using artificial intelligence.

14. A system, comprising or interfacing with:
a set of cloud platforms that include at least one of:
an electronic commerce (e-commerce) platform,
an electronic logistics (e-logistics) platform,
an electronic finance (e-finance) platform, or
an electronic insurance (e-insurance) platform; and
an analytics platform that includes:
one or more communication interfaces for interacting with the set of cloud platforms,
one or more memories,
one or more processors, communicatively coupled to the one or more memories, configured to:
identify, using a data intake module, one or more universal data elements;
receive, using the data intake module and via at least one of the one or more communication interfaces, profile information for an entity, the entity being associated with the one or more universal data elements;
receive, using the data intake module and via at least one of the one or more communication interfaces, commercial activity information and documentation information associated with the entity;
identify Ultimate Data Quality (UDQ) using the one or more universal data elements, the profile information, the commercial activity information, and the documentation information;
generate performance attribute metrics associated with the entity based on the UDQ and one or more performance factors associated with the entity; and
generate an overall performance score for the entity using the performance attribute metrics.

15. The system of claim 14, wherein the one or more processors of the analytics platform are further configured to filter, using a filtering module, at least one of:
the one or more universal data elements,
the profile information,
the commercial activity information, or
the documentation information.

16. The system of claim 14, wherein the UDQ is based on automated validation or validation by the participants, of at least one of: the one or more universal data elements, the profile information, the commercial activity information, or the documentation information.

17. The system of claim 14, wherein the one or more processors of the scoring platform are configured to generate the performance attribute metrics using a first scoring module.

18. The system of claim 14, wherein the one or more processors of the analytics platform are configured to generate the overall performance score using a second scoring module that is driven by machine learning.

19. The system of claim 14, wherein the one or more processors of the analytics platform are configured to receive, via the one or more communication interfaces, at least one of:
the profile information,
the commercial activity information, or
the documentation information.

20. The system of claim 14, wherein the analytics platform further comprises:
an output component for displaying the overall performance score.
